(19) United States
(12) Patent Application Publication
(10) Pub. No.: US 2004/0259672 A1
(43) Pub. Date: Dec. 23, 2004

(54) Belt tensioner

(75) Inventor: Hans-Peter Betz, Boebingen (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Automotive GmbH

(21) Appl. No.: 10/830,332

(22) Filed: Apr. 22, 2004

(30) Foreign Application Priority Data
Jun. 20, 2003 (DE) 103 27 837.0

(51) Int. Cl. F16H 7/08

(52) U.S. Cl. 474/101; 474/109

(57) ABSTRACT

A belt tensioner (10) includes a housing part (12). The housing part (12) includes an elongated cylinder tube (18) in which a piston (14) is displaceably arranged. The belt tensioner (10) also includes a drive (16) which can exert a driving force onto the piston (14). The housing part (12) is constructed in a T-shape with a foot section (20) extending transversely away from the cylinder tube (18). The cylinder tube (18) is constructed in one piece with the cylinder tube and forms an accommodation space (30) for the drive (16). In a method for manufacturing such a belt tensioner (10), the foot section (20) forming the accommodation space (30) for the drive (16) is constructed in the housing part (12) by internal high pressure deformation.

### TECHNICAL FIELD

The invention relates to a belt tensioner. The invention further relates to a method for manufacturing a belt tensioner.

### BACKGROUND OF THE INVENTION

From published German patent application, DE 43 07 062 A1, a belt tensioner is known which comprises a housing part including an elongated cylinder tube in which a piston is displaceably arranged. The known belt tensioner further comprises a drive which can exert a driving force onto the piston. The housing part sits in a base block. In the base block a drive chamber is constructed in which a gas generator is situated. In order to be able to withstand the explosion pressure of the gas generator, the base block must have a sufficient strength and is therefore, even if it is made of light metal, very solid and thereby heavy.

### BRIEF SUMMARY OF THE INVENTION

It is an object of the invention to provide a low-weight belt tensioner which is simple to manufacture.

The belt tensioner according to the invention comprises a housing part including an elongated cylinder tube. In the cylinder tube a piston is displaceably arranged. The belt tensioner further comprises a drive which can exert a driving force onto the piston. The housing part is constructed in a T-shape with a foot section extending transversely away from the cylinder tube, the foot section is constructed in one piece with the cylinder tube and forms an accommodation space for the drive. The accommodation space for the drive, integrated into the housing part, renders a separate base block for the drive dispensable. Therefore, the weight and the installation step for the additional base block can be saved. By the T-shaped construction of the housing part with the drive housed in the foot section, it is avoided that the burning of the drive directly impairs a traction means, for example a traction cable, running in the housing part.

According to a second aspect, the invention provides a method for manufacturing such a belt tensioner. The foot section forming the accommodation space for the drive is constructed in the housing part by internal high pressure deformation. With this method, the housing part can be produced in less process steps. In particular, no additional component is to be handled and fastened to the housing part for the construction of the foot section.

Advantageous embodiments of the invention will be apparent from the sub-claims.

### BRIEF DESCRIPTION OF THE DRAWINGS

FIG. 1 shows a longitudinal section through a belt tensioner according to the invention;

FIG. 2 shows the enlarged detail II of FIG. 1;

FIG. 3 shows the enlarged detail III of FIG. 1; and

FIG. 4 shows a longitudinal section through the housing part of the belt tensioner of FIG. 1 in an intermediate step of the manufacturing process according to the invention.

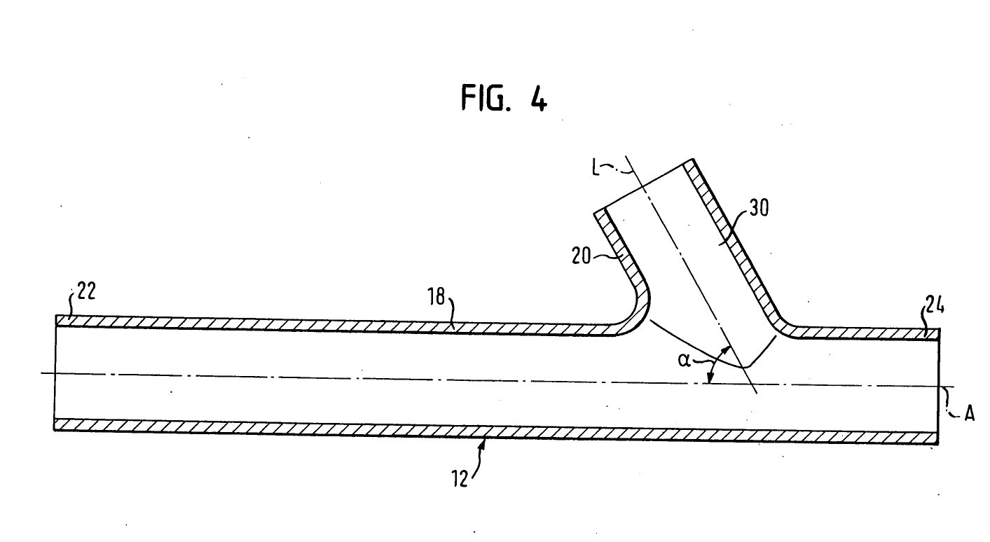

### DETAILED DESCRIPTION OF THE PREFERRED EMBODIMENT

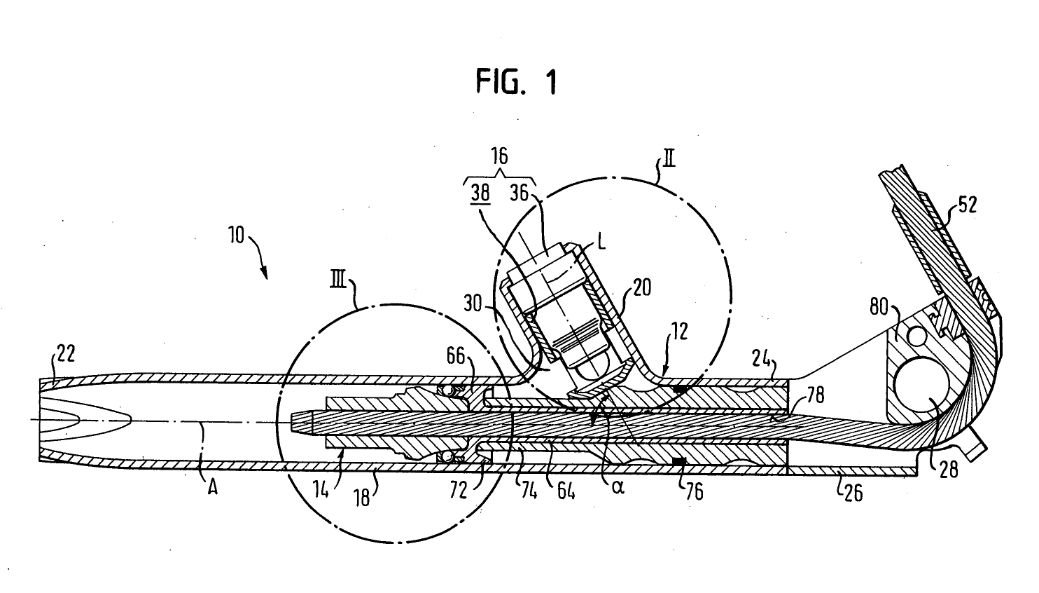

In FIG. 1 a belt tensioner 10 can be seen, which has a drive 16 and a housing part 12, in which a piston 14 is displaceably guided.

The housing part 12 has substantially the shape of a large T lying on its head (according to the figures), with an elongated cylinder tube 18 and a foot section 20. The cylinder tube 18, which defines a longitudinal axis A of the housing part 12, has a front end 22, a rear end 24 and is of circular cross-section. At the front end 22, the cylinder tube 18 is narrowed conically, in order to prevent an emergence of the piston 14. At the rear end 24, a fastening part 26 with a fastening bore 28 is provided, for installation of the belt tensioner 10 in the vehicle. The fastening part 26 can be constructed in one piece with the housing part 12.

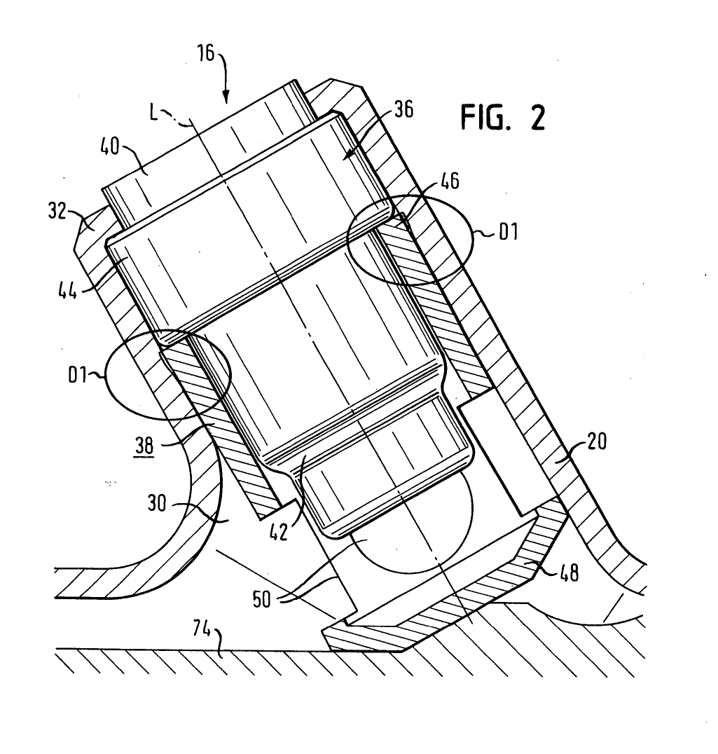

The foot section 20 extends from the rear half of the cylinder tube 18 transversely away from the longitudinal axis A of the housing part 12 up to a free end 32 (see FIG. 2) and forms an accommodation space 30 for the drive 16. The foot section 20 preferably likewise has a circular cross-section, its longitudinal axis L intersecting the longitudinal axis A of the housing part 12 at an angle α.

The drive 16, which is illustrated on an enlarged scale in FIG. 2, comprises a gas generator 36 and a gas generator bushing 38. The gas generator 36 has a base 40, a body 42 and a belt 44, the diameter of the belt 44 being greater than the diameter of the base 40 and of the body 42. The base 40 projects out from the free end 32 of the foot section 20. The edge of the free end 32 of the foot section 20 is flanged and secures the gas generator 36 on the belt 44, which rests on the gas generator bushing 38. The belt tensioner according to the invention is suitable both for gas generators with a plug connection and also for those with cable connections.

The gas generator bushing 38 comprises a cup-like sleeve with an open head end 46 and a foot end 48 which is closed in longitudinal direction. The bushing 38 surrounds the body 42 of the gas generator 36, the head end 46 lying against the belt 44. At the foot end 48, the gas generator bushing 38 is provided with bores 50, through which the gas generated by the gas generator 36 can emerge into the interior of the housing part 12.

The gas generator bushing 38 is elastic with a flexibly adapting diameter. Therefore, the gas generator 36 is not only positioned in the accommodation space 30 by the gas generator bushing 38, but is also sealed against the wall of the foot section 20, the internal diameter of which may be subject to tolerance. For this, the gas generator bushing 38 can advantageously be widened in diameter or thickened at the head end 46, in order to effectively seal in particular the region designated by D1 in FIG. 2.

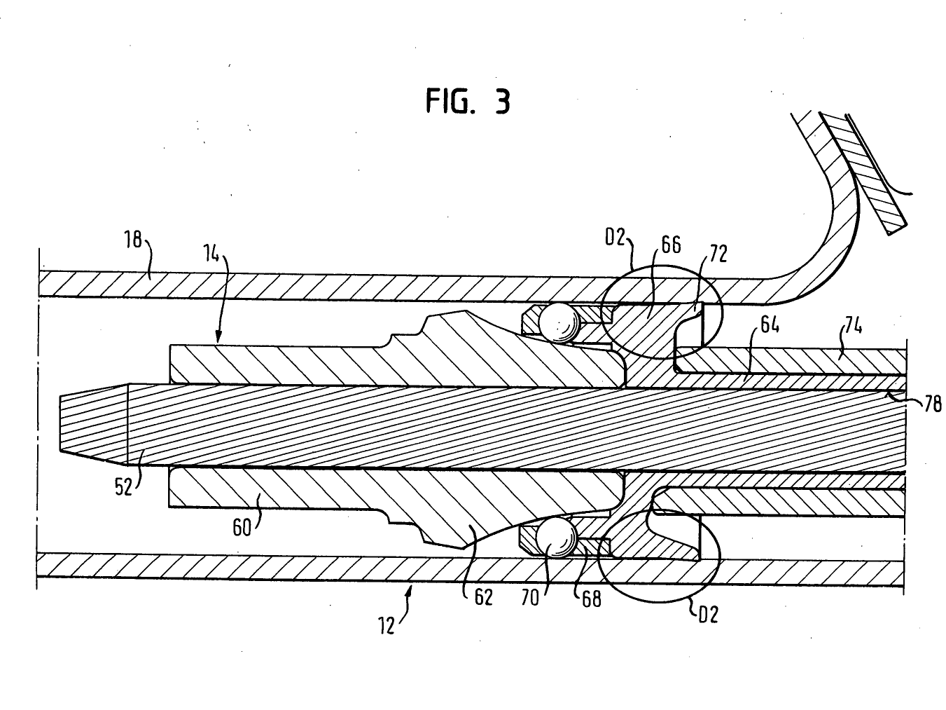

The piston 14, which is to be seen more precisely in FIG. 3, is pressed onto an end of a traction cable 52. The piston 14 has a front cylinder section 60 and a rear cone section 62, to which a protective sleeve 64 adjoins. The sleeve 64 surrounds the traction cable 52 for protection against the hot gases of the gas generator 36. Whereas the protective sleeve 64 surrounds the traction cable 52 as a thin covering towards the rear end 24 of the cylinder tube 18, it forms a ram 66 in the place where it adjoins the cone section 62 of the piston 14. The ram 66 fills the cross-section of the cylinder tube 18.

The ram 66 is provided at a forward-pointing end with a crown 68, which surrounds the cone section 62 and in which balls 70 are held. The balls 70, after a belt tensioning process on drawing back of the piston 14, jam between the wall of the cylinder tube 18 and the cone section 62. Thereby, a withdrawal barrier with belt force limitation is formed, which is already known from the prior art and therefore is not described in further detail.

At the rearwardly pointing end of the ram 66, an encircling sealing lip 72 is formed, which presses against the wall of the cylinder tube 18. The sealing lip 72 balances out tolerances in the internal diameter of the cylinder tube 18 and therefore forms a seal for the piston 14 in the region designated by D2 in FIG. 3.

At its rear end 24, the cylinder tube 18 is closed with a guide sleeve 74, which extends up to the ram 66. The guide sleeve 74 is provided with a through-bore 78 concentric to the longitudinal axis A of the housing part 12. In the through-bore 78 the traction cable 52 is guided. In addition, the guide sleeve 74 is sealed against the wall of the cylinder tube 18 by a sealing ring 76.

The traction cable 52 is deflected at a guide element 80 in the fastening part 26 and can be fastened at its other end, which is not illustrated in the drawings, for example to a belt end fitting or to a belt buckle.

A further advantage of the belt tensioner 10 according to the invention consists in that the diameter of the foot section 20 corresponds to the diameter of the longitudinal tube 18, so that the overall width of the tensioner is not wider than the external diameter of the longitudinal tube 18. This is particularly advantageous when the belt tensioner 10 is to be constructed in the narrowed region between the seat and middle tunnel of a vehicle.

In the embodiment shown in the drawings, the foot section 20 projects upwards, so that the housing part 12 has the form of a large T standing on its head. Of course, the foot section 20 can be arranged at various angles α to the longitudinal axis A. All such developments of the housing part 12 are designated as T-shaped. The foot section 20 can also be constructed radially on the circumference of the housing part 12 in any desired orientation with respect to the longitudinal axis A, or the housing part 12 can be connected at different orientations with respect to the longitudinal axis A with the fastening part 26. Thus, with only one embodiment of the housing part 12, different structural forms of a belt tensioner can be realized. The possibilities for variation in the development of the housing part 12 make it possible to take into account restrictions of structural space and to aim for optimum flow conditions for the gas generated by the gas generator 36.

The housing part 12 with the integrated foot section 20 can be advantageously constructed as a steel tube, so that a considerable saving on weight results compared with belt tensioners, for example, with a gas generator housing of die cast zinc. The design of the cylinder tube 18 is not restricted to a circular cross-section, but rather can of course also have a different cross-sectional shape.

The foot section 20 can be constructed in various ways on the housing part 12, for example by being welded on. Particularly advantageously, it can be constructed through the use of the internal high pressure deformation known per se, as is the case in the method described below.

In the manufacture of the belt tensioner 10, a dome is formed by internal high pressure deformation in a cylindrical tube. The dome later forms the foot section 20. The dome is cut open, so that the intermediate product illustrated in FIG. 2 results. The front end 22 of the housing part 12 is narrowed, and the piston 14 and the guide sleeve 74 are introduced into the housing part 12. The sealing lip 72 on the ram 66 advantageously is able to balance out the tolerances in the diameter of the housing part 12 originating in particular from the internal high pressure deformation.

For the installation of the drive 16, the gas generator 36 is introduced with the gas generator bushing 38 into the foot section 20 and is positioned therein. The gas generator bushing 38, in turn, is able to balance out through its elasticity any tolerances in the diameter of the foot section 20. The fastening of the drive 16 takes place by flanging the edge at the free end 32 of the foot section 20. Preferably, the gas generator bushing 38 is pushed in so far that it lies with its foot end 48 against the guide sleeve 74 (FIG. 2). Thereby, it is fixed axially between the guide sleeve 74 and the flanged free end 32.

1. A belt tensioner (10) comprising
a housing part (12) including an elongated cylinder tube (18) in which a piston (14) is displaceably arranged, and
a drive (16) which can exert a driving force onto the piston (14),
characterized in that the housing part (12) is constructed in a T-shape with a foot section (30) extending transversely away from the cylinder tube (18), the foot section (30) being constructed in one piece with the cylinder tube (18) and forming an accommodation space (30) for the drive (16).

2. The belt tensioner according to claim 1, characterized in that the foot section (20) is welded to the cylinder tube (18).

3. The belt tensioner according to claim 1, characterized in that the foot section (20) is produced in the housing part (12) by internal high pressure deformation.

4. The belt tensioner according to claim 1, characterized in that the drive (16) includes a gas generator (36) and a gas generator bushing (38).

5. The belt tensioner according to claim 4, characterized in that the gas generator bushing (38) comprises a flexible seal (46).

6. The belt tensioner according to claim 1, characterized in that the piston (14) is provided with a flexible sealing lip (72).

7. A method for manufacturing a belt tensioner (10) according to claim 1, characterized in that the foot section (20) forming the accommodation space for the drive (16) is constructed in the housing part (12) by internal high pressure deformation.
